(19) United States
(12) Patent Application Publication
(10) Pub. No.: US 2020/0245612 A1
(43) Pub. Date: Aug. 6, 2020

(54) Mandible Clamping Device

(71) Applicant: Chris Coleman, Hastings, FL (US)

(72) Inventor: Chris Coleman, Hastings, FL (US)

(21) Appl. No.: 16/265,156

(22) Filed: Feb. 1, 2019

(51) Int. Cl. A01N 1/00

(52) U.S. Cl. CPC A01N 1/00

(57) ABSTRACT

The positioning of the mandible clamp within the person's jaw or mouth is accomplished by either of two embodiments. One embodiment uses a pair of flanged surface that allow a person to push a barb through the person's gum structure on the upper jaw and lower jaw. This first embodiment contemplates use for a period who has natural teeth at the time of death. The second embodiment resembles a clamp that is placed over the person's gum to secure the jaw bones together. This second embodiment is used with person's who did not have natural teeth at the time of death. After the respective openings are placed over the gum areas of the person's upper and lower gums a tension member slides over the outside surface of the clamp to produce gripping of the gum by the device. A plurality of gripping knobs is provided to produce additional grip on the person's gums.

### FIELD OF THE INVENTION

This device teaches a device to clamp the jaw together for presentation in a funeral setting. It is customary, whenever someone passes away, in order to maintain the integrity of the body and to make an appropriate appearance for the family and loved ones of the deceased. The jaw and mouth are closed to prevent an opening in the mouth of the deceased. Additionally there should be respect for the body and the desire to minimize mutilation of the body should also be contemplated. This device, which consists of two embodiments, is a simple, easy way to make sure that the mandible and the maxilla positions (lower and upper jaw bones) and shut and the lips shield the device from the family members.

### PRIOR ART

There are other prior art references in the prior art that discuss devices that hold the jaw open or closed. Most of the prior art discuss patents that are in the dental field and a representative example of this can be found at Young, U.S. Pat. No. 5,605,456, which is a dental articulator. This device has a different function than the current application. Another reference that also pertains to the dental filed can be found at Page, U.S. Pat. No. 2,968,868 is a mandible clamp but this clamp has a completely different structure.

### BRIEF SUMMARY OF THE INVENTION

Whenever a person passes away, in order to appropriately present the body for the loved ones, among other things, the funeral personnel will clamp the jawbones together so that there is no opening in the mouth that is seen by the loved ones of the deceased. In the prior art a specific gun and the use of wires has been used to tape the person's mouth shut. Another method that is found in the prior art is by using string that is strung through the nasal passages to clamp the jaw bones together. Neither of the prior art references expose the attachment method to the family.

The use of the gun and the stringing method, however, may lead to some mutilation of a body which is to be minimized at all costs.

This device has two embodiments. One is intended to be used for those persons who die with natural teeth and the second is to be used with people who die without teeth. The stated purpose of either embodiments is to secure the jaw bones together and to make sure that the jaw bones stay shut.

The first embodiment is used when the individual has teeth present. The device will be inserted into the area of the upper jaw bone (maxilla) gum above the area of the teeth and approximately three-quarters to one and a quarter inches the other part of the device is inserted into the lower jaw bone (mandible) through the gum. In this first embodiment a flanged surface with a curved barb at the opposite end is placed in the person's gum above the area of the teeth near the center of the mouth in the upper jaw bone and the lower jaw bone. This first flanged surface is connected to a second flanged surface; the second flanged surface with a corresponding barb at the opposite end of the flanged surface is positioned in the area of the lower jaw bone (mandible) and placed in the person's gum below the area of the teeth in the lower jaw. When the device is installed the person's gums will cover the device after it is positioned in the person's mouth. This device will remain with the person.

The second embodiment is designed for people who die without natural teeth. In this embodiment the device resembles a C-clamp that can be locked in place with the use of another arcuate portion that fits over the C-clamp to tighten the device around the gum structure of the person. In the interior of the C-clamp a plurality of knobs or protrusions are provided to produce grip to the person's upper and lower jaw bone. This device, like the first device, remains with the person.

### BRIEF DESCRIPTION OF THE DRAWINGS

FIG. 1 is an isometric view of the first embodiment.

FIG. 2 is a side view of the first embodiment showing the flanged surfaces and the barbs.

FIG. 3 is a top view of the first embodiment.

FIG. 4 is an isometric view of the second embodiment.

FIG. 5 is a reverse isometric view of the second embodiment.

FIG. 6 is a side view of the second embodiment.

FIG. 7 is a top view of the second embodiment.

### NUMBERING REFERENCES

1 First Embodiment
5 Flanged surface
10 Barb
15 Stem
20 Connecting Bar
50 Second Embodiment
55 Clamp
60 Tension Member
65 Gripping Knobs

### DETAILED DESCRIPTION OF THE EMBODIMENTS

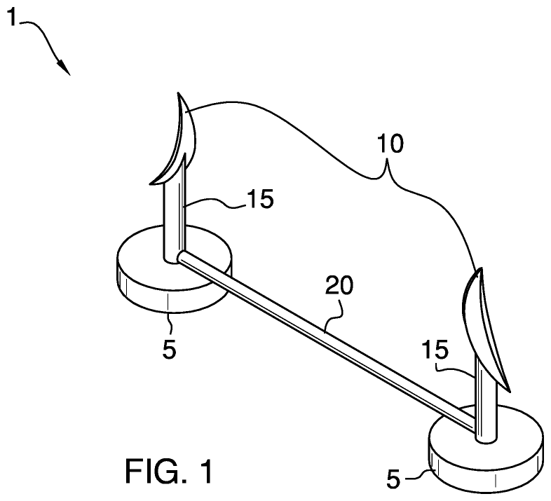

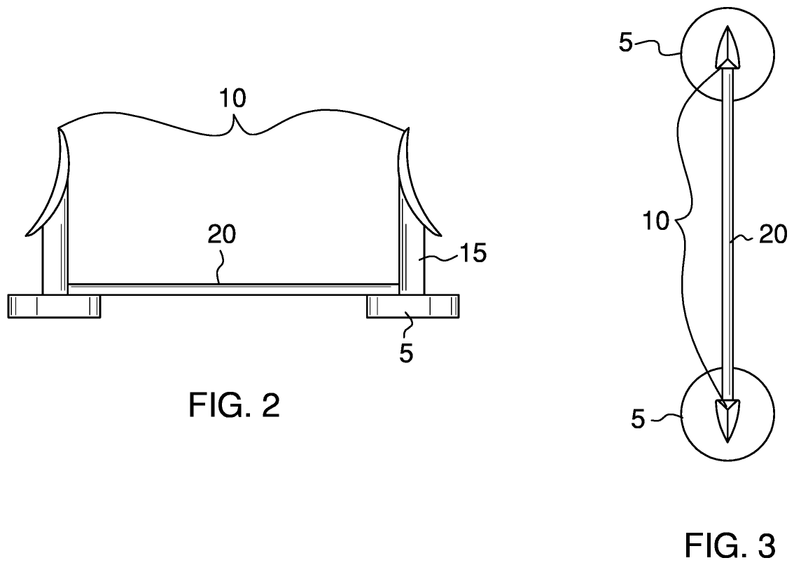

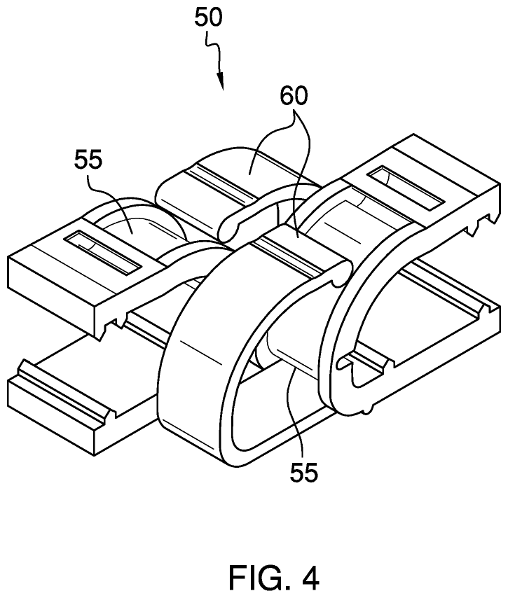

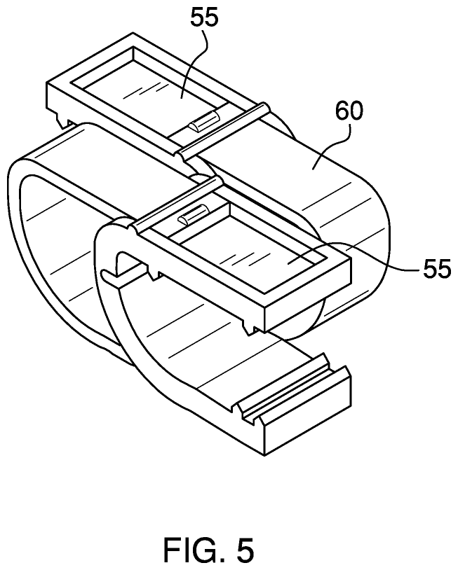

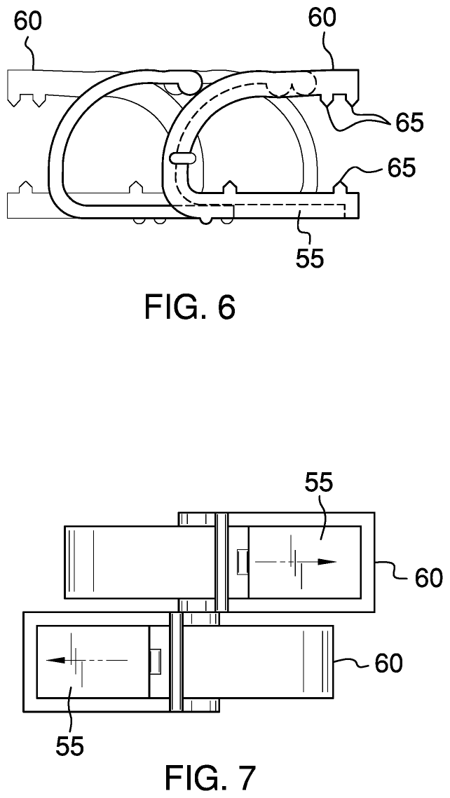

Two separate embodiments are taught in this application. The first of the embodiments is depicted in FIGS. 1-3 and the second embodiment is depicted in FIGS. 4-7. The first embodiment 1 is used with persons who die with natural teeth and the second embodiment 50 is used with people who die without natural teeth. Regardless of whether the person dies with or without teeth the function of either embodiment is still the same: keeping the person's jaw bones together to present to the family after that person has died.

This device with either embodiment is covered by the person's lips so that it is not seen by family members and loved ones; the device remains with the body.

### First Embodiment

Two flanged surfaces 5 are attached to a stem 15 with a curved barb 10 at the opposite end of the flanged surface. The mandible clamping device is comprised of a pair of flanged surfaces with attached stems 15 and a curved barb 10 at the end of the respective stems.

The wear in flat surface is used to pushed the curved surface into the person's gum. So they can wear a connection piece secures the top flat surface with the bottom flat surface.

One of the curved barbs 10 is inserted in the maxilla (upper jaw bone) through the person's gum and the other curved barb 15 is placed through the gum of the mandible (lower jaw bone). The curvature of the barb prevents the barb from backing out of the gum to insure that the person's mouth does not open. The flanged surfaces are connected to each other with a connecting bar 20. A pair of stems 15 connect the flanged surface to the curved barb 10. The distance between the flanged surfaces is between three-quarters and one and one-half inches.

### Second Embodiment

The second embodiment 50 teaches a mandible clamping device which is to be used with a person who dies without natural teeth. The second embodiment is in the shape of a C clamp and the openings of the respective “Cs” are placed over the upper and lower gums of the person. The two sections of the device are connected together to ensure that the mouth of the person remains shut.

On the outside surface of the claim 55 is another tension member 60 that slides over the outside of the claim and cause the opening of the “C” to clamp around the gums of the person.

A plurality of gripping knobs are placed in the interior space of the respective “Cs” to provide additional grip to the gums of the person. The C-clamp is placed in the person's gum and the C-clamp insures that the device is securely fastened to the person's gum. This embodiment like the first embodiment remains with the person.

The inventor claims:

1. A mandible clamping device, which is comprised of
a pair of flanged surfaces;
a pair of barbs;
a pair of stems;
wherein the stems connect the flanged surfaces to the barbs;
a connecting rod;
wherein the connecting rod connects the pair of flanged surfaces;
wherein the length of the connecting rod is in the range of three-fourth inch and one and a half inches.

2. A mandible clamping device, which is comprised of:
a clamp;
a tension member;
a plurality of gripping knobs;
wherein the tension member slides over the clamp.
